(19) United States
(12) Patent Application Publication
(10) Pub. No.: US 2003/0225512 A1
(43) Pub. Date: Dec. 4, 2003

(54) Apparatus and method for providing user with road traffic information

(76) Inventors: Jong-Ho Kim, Uiwang-Si (KR); Yong-Deak Kim, Seongnam-Si (KR)

Correspondence Address: CANTOR COLBURN LLP, 55 Griffin Road South, Bloomfield, CT, 06002, US

(21) Appl. No.: 10/448,924

(22) Filed: May 29, 2003

(30) Foreign Application Priority Data
May 30, 2002 (KR) 2002-30420

(51) Int. Cl. G01C 21/34

(52) U.S. Cl. 701/209; 340/995.13

(57) ABSTRACT

An apparatus and method provides a user with road traffic information using teletext broadcast data. The apparatus extracts ID information of a unit road contained in a prescribed range from electronic map data using a GPS signal and an electronic map DB signal, selects road traffic information corresponding to the extracted unit road ID information from all the road traffic information, contained in digital teletext broadcast data, for every unit road of an overall road network, and informs the user of the selected road traffic information. The apparatus gains access to needed electronic map data stored in an electronic map DB, displays the accessed electronic map data on a display, receives a GPS signal, and reflects current position and direction information of a vehicle on the electronic map

### BACKGROUND OF THE INVENTION

1. Field of the Invention

The present invention relates to an apparatus and method for providing a user with road traffic information, and more particularly to an apparatus and method for providing a user with road traffic information using teletext broadcast data.

2. Description of the Related Art

In the case where a user wishes to acquire road traffic information associated with a specified area at his or her desired time, a conventional communication device cannot satisfy the user's demand due to the following disadvantages.

Firstly, a roadside or outdoor installation such as an electric sign board charges no usage fee for road traffic information from a user, and is able to provide unspecified people with road traffic information. However, information acquisition places of the user are limited to a few prescribed places, and a user is unable to receive information associated with his or her desired area.

Secondly, information provided in the form of ARS (Automatic Response System) message or text message can be provided to a user as road traffic information associated with a user's desired area, but the user must pay an information provider a high usage fee for such information.

Thirdly, in the case where a user receives voice information from the radio, there is no usage fee for the information, however, there is a disadvantage in that it is difficult for the user to acquire road traffic information associated with his or her desired area at a desired time.

In order to solve the above disadvantages, various additional information is multiplexed and loaded on general broadcast radio signal, and thus such multiplexed additional information is finally transmitted to a user. Therefore, the user can receive such additional information with a lower cost by a simple method.

In this way, a general FM broadcast system adds RDS (Radio Digital System) signals or DARC (Data Radio Channel) signals to radio broadcast signals, and transmits the resultant radio broadcast signals having the RDS or DARC signals, such that the broadcast system can allow a user to hear such a radio broadcast signal and receive various information other than the radio broadcast signal.

A representative road traffic information transmission system using a FM DARC is described in Korean Patent Publication No. 10-0325092, entitled “SYSTEM AND METHOD FOR TRANSMITTING ROAD TRAFFIC INFORMATION USING FM DARC” issued on Feb. 5, 2002, such that the road traffic information being variable in real time is added to general broadcast audio signals within a FM DARC (Frequency Modulation Data Radio Channel) bandwidth, resulting in reduction of a usage fee for information. Particularly, the aforementioned road traffic information transmission system uses a code-based scheme instead of a typical text-based scheme, such that it can be more effectively and conveniently applied to a CNS (Car Navigation System) or a mobile communication terminal.

However, road traffic information transmitted to a user through a teletext broadcast channel (e.g., a DARC) is broadcast to unspecified people such as drivers, irrespective of a current position of a specified driver. Therefore, in order to allow the specified driver to acquire his or her desired information, the specified driver must wait for a predetermined time during which unwanted information is received.

In addition, although user-desired information is included in the received teletext broadcast data, and is then transmitted to the user through an output device of the road traffic information transmission system, it is impossible for the road traffic information transmission system to provide a user with the user-desired information in real time, such that the user cannot go around a congested road due to receiving his or her desired information at too late a time.

### SUMMARY OF THE INVENTION

Therefore, the present invention has been made in view of the above problems, and it is an object of the present invention to provide an apparatus and system for providing a user or driver with road traffic information, which selects necessary road traffic information from among received teletext broadcast data, and informs the user or driver of only the selected road traffic information.

It is another object of the present invention to provide an apparatus and method for providing a user or driver with road traffic information, which selects road traffic information associated with a prescribed area contained in an electronic map from among teletext broadcast data, and informs the user or driver of the selected road traffic information.

It is yet another object of the present invention to provide an apparatus and method for providing a user or driver with road traffic information, which extracts identification (ID) information of a unit road contained in a prescribed area from electronic map data using a GPS (Global Positioning System) signal and an electronic map database (DB) signal, selects road traffic information corresponding to the extracted unit road ID information from all the road traffic information, contained in digital teletext broadcast data, for every unit road of an overall road network, and informs the user or driver of the selected road traffic information.

It is yet another object of the present invention to provide an apparatus and method for providing a user or driver with road traffic information, which determines an appropriate range on an electronic map using a GPS signal and an electronic map DB signal on the basis of a position and traveling direction of a vehicle, extracts ID information of a unit road contained in the determined range from the received data, selects road traffic information corresponding to the extracted unit road ID information from all road traffic information for every unit road of an overall road network contained in digital teletext broadcast, and audibly informs the user or driver of the selected road traffic information via a voice message.

In accordance with one aspect of the present invention, the above and other objects can be accomplished by the provision of an apparatus and method for providing a user or driver with road traffic information, which extracts only unit road ID information of a prescribed area on an electronic map, and selectively provides the driver with only road traffic information corresponding to the extracted unit road ID information from among received teletext broadcast data.

Therefore, the present invention selects only road traffic information associated with a specified area requested by the driver from among all road traffic information received via a teletext broadcast, and informs the driver of only the selected road traffic information.

Preferably, the external data output unit may include: a voice memory for storing unit road ID information used as the digital teletext broadcast data and current road traffic condition information code for every unit road as voice data; and a voice processor for examining unit road ID information contained in the road traffic information selected by the data selector and current road traffic condition information code for every unit road, extracting voice data corresponding to the examined information from the voice memory, audibly reproducing the extracted voice data, and outputting the reproduced voice data.

Therefore, the present invention informs the driver of the selected road traffic information using voice data or message, such that the driver quickly and accurately recognizes the road traffic information and the driver is able to continue driving safely.

In accordance with another aspect of present invention, there is provided a method for extracting unit road ID information of a prescribed area contained in the electronic map, including the steps of: recognizing current position and direction information of the vehicle; and determining a prescribed area according to the current position and direction information of the vehicle on the electronic map, and extracting unit road ID information associated with the prescribed area.

Therefore, a window size is reset according to a current vehicle position, such that the window is shifted to a predetermined location on the electronic map, and the size of window can be adjusted according to traffic volume to be transmitted to the driver.

In accordance with still another aspect of present invention, there is provided a method for extracting unit road ID information of a prescribed area contained in the electronic map, including the steps of: recognizing current position and direction information of the vehicle; searching for name information of a unit road on which the vehicle is positioned on the electronic map; and extracting unit road ID information corresponding to the searched unit road name.

Therefore, the present invention is able to effectively provide a user or driver with road traffic information on the condition that a vehicle runs along only one road.

In accordance with still another aspect of present invention, there is provided a method for extracting unit road ID information of a prescribed area contained in the electronic map, including the steps of: recognizing destination of a driver; calculating a center coordinate closest to the destination; recognizing current position and direction information of the vehicle; and extracting unit road ID information associated with a prescribed area located in an approach direction of the vehicle directed to the center coordinate, on the basis of the center coordinate.

Therefore, the present invention is effectively adapted to the case where the driver moves his or her vehicle on the basis of a specified center point or coordinate, and all roads are arranged in the form of radial roads.

In accordance with still further aspect of present invention, there is provided a method for extracting unit road ID information of a prescribed area contained in the electronic map, including the steps of: recognizing destination information of a driver, and current position and direction information of the vehicle; creating a window of a prescribed diameter and width to include the current position and direction information of the vehicle; obtaining a road network's node contained in the window; calculating an optimum path from the current vehicle position to the destination using the obtained road network's node; and extracting unit road ID information corresponding to the calculated optimum path.

Therefore, a network size used for extracting the optimum path may be unrelated to the size of a real network, and the optimum path extraction may be performed using the created sub-network, such that the optimum path can be extracted in real time.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a block diagram of an apparatus for providing a user with road traffic information in accordance with the present invention;

FIG. 2 is a flow chart illustrating a method for providing a user with road traffic information in accordance with the present invention;

FIG. 3a is an exemplary view illustrating a method for extracting road traffic information using window information from reception data in accordance with the present invention;

FIG. 3b is a flow chart illustrating the road traffic information extraction method shown in FIG. 3a in accordance with the present invention;

FIG. 4a is an exemplary view illustrating a method for extracting road traffic information from reception data using road name information in accordance with the present invention;

FIG. 4b is a flow chart illustrating the road traffic information extraction method shown in FIG. 4a in accordance with the present invention;

FIG. 5a is an exemplary view illustrating a method for extracting road traffic information from reception data using center point information in accordance with the present invention;

FIG. 5b is a flow chart illustrating the road traffic information extraction method shown in FIG. 5a in accordance with the present invention;

FIG. 6a is an exemplary view illustrating a method for providing a user with road traffic information using a mixed scheme in accordance with the present invention;

FIG. 6b is a flow chart illustrating the road traffic information transmission method shown in FIG. 6a in accordance with the present invention;

FIG. 7 is a flow chart illustrating a method for extracting road traffic information by calculating an optimal path from a current position to a destination in accordance with the present invention;

FIG. 8 is a conceptual diagram illustrating a method for creating a window between a starting point and a destination in accordance with the present invention;

FIG. 9 is a conceptual diagram illustrating a method for determining a sub-network of an overall road network on the basis of the created window in accordance with the present invention;

FIG. 10 is a conceptual diagram of Dijkstra's algorithm in accordance with the present invention; and

FIG. 11 is a view illustrating an example of unit roads contained in an overall road network in accordance with the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

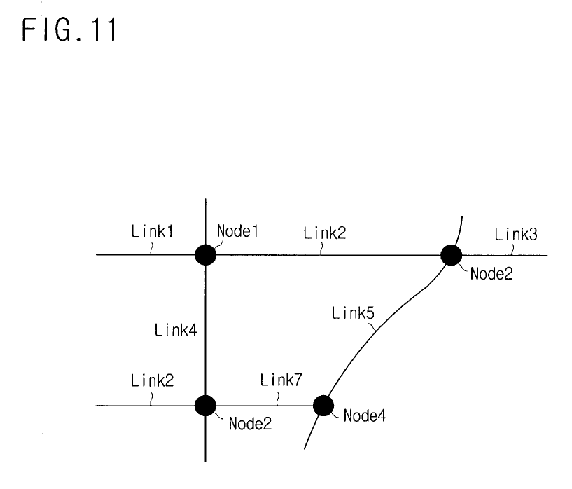

Prior to describing the present invention, it should be noted that unit road identification (ID) information indicates ID information for discriminating individual unit roads contained in an overall road network on an electronic map. Such unit road can be represented in the form of a system composed of nodes or links. As shown in FIG. 11, this node indicates a section point for classifying roads on an electronic map, for example, a crossroads or a cross street with three corners, etc. This link functioning as a basic unit for involving road traffic information, and is composed of a start node, an end node, and an interval between the start node and the end node.

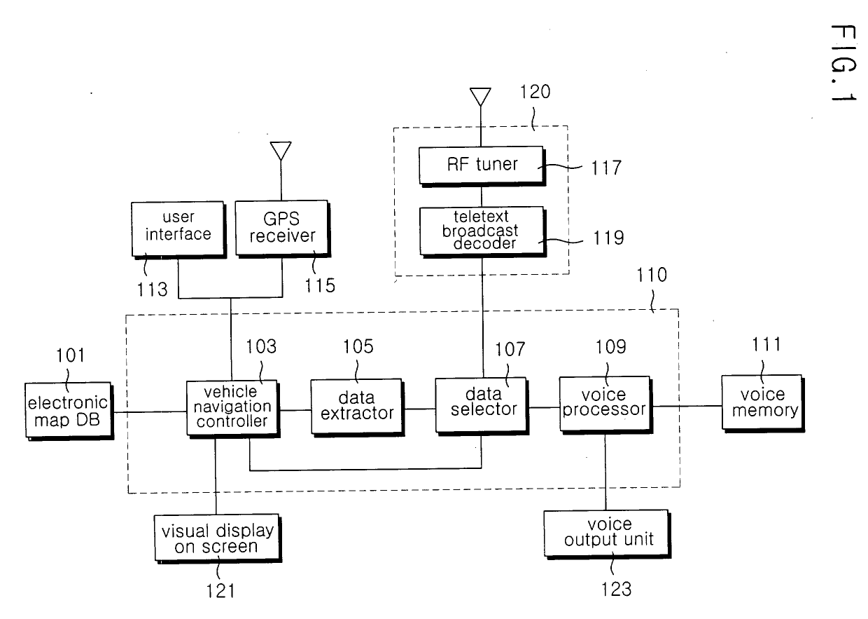

FIG. 1 is a view illustrating a block diagram of an apparatus for providing a user with road traffic information in accordance with the present invention.

The road traffic information transmission apparatus in accordance with the present invention can be built in a typical vehicle navigation system.

Referring to FIG. 1, the road traffic information transmission apparatus functioning as a vehicle navigation system includes an electronic map database (DB) 101 for storing electronic map data, a vehicle navigation controller 103 for accessing the electronic map DB 103 to search for necessary data, displaying the searched data on a display, calculating a current position and a traveling direction of a vehicle, and reflecting the calculated result on an electronic map, a GPS receiver 115 for receiving a GPS signal, and providing a user with current vehicle position information, a user interface 113, and a visual display 121.

The road traffic information transmission apparatus further includes a teletext broadcast receiver 120. The teletext broadcast receiver 120 can be easily applied to the present invention because it is being widely used as a commercial product.

The teletext broadcast receiver 120 mainly includes a RF (Radio Frequency) tuner 117 and a teletext broadcast decoder 119. The RF tuner 117 selects a DARC (Data Radio Channel) from among a plurality of radio signals, and the teletext broadcast decoder 119 decodes the teletext broadcast data.

The electronic map DB 101 may be replaced with a GIS (Geographic Information System) DB. Images in the form of data or a real map are stored in the electronic map DB 101. The electronic map DB 101 stores information associated with a road network on an electronic map, and also stores ID information for classifying individual unit roads contained in an overall road network.

The data extractor 105 extracts ID information of a unit road contained in a prescribed area from all data displayed on an electronic map. The data extractor 105 will be described in more detail at a later time.

The data selector 107 selects road traffic information corresponding to ID information of a unit road extracted by the data extractor 105 from among teletext broadcast data received from the teletext broadcast decoder 119.

In more detail, the teletext broadcast data includes road traffic information for every unit road contained in an overall road network such as the national road network. For example, teletext broadcast data includes a data field composed of a predetermined number of bytes to discriminate individual unit roads. This data field for each unit road includes a variety of road traffic information, for example, traffic accident information, stalled vehicle information, event or public assembly information, road repair work information, weather condition information, traffic obstacle information, and a transit time, etc.

The data selector 105 selects only road traffic information corresponding to unit road ID information contained in a prescribed area on an electronic map from among all road traffic information for every unit road contained in an overall road network.

The road traffic information selected by the data selector 105 is outputted through a visual display 121 or a voice output unit 123.

The voice memory 111 stores unit road ID information for use in road traffic information data as voice data, and also stores name or title information corresponding to current traffic condition information codes for every unit road as voice data.

The voice processor 109 examines unit road ID information contained in the selected road traffic information and a current traffic condition information code for every unit road. The voice processor 109 extracts voice data corresponding to the unit road ID information and the current traffic condition information code from the voice memory 111, and converts the extracted voice data written in digital data into analog data. The voice processor 109 audibly informs a user or driver of the resultant road traffic information data through the voice output unit 123 such as a voice playback circuit.

The visual display 121 (e.g., a video display such as an LCD) is adapted to inform the driver of the selected road traffic information, and of course, the selected road traffic information can be audibly output to the driver through the voice output unit 123. Provided that the road traffic information transmission system uses text data, a data processing operation can be performed with a small amount of data, and desired data can be easily stored or processed in the road traffic information transmission system. However, it is difficult for this text data method to quickly and accurately transmit the meaning of road traffic information to the user or driver, as compared to the voice data method. Provided that the user or driver directly enters text data to transmit desired information, the driver is not able to continue driving safely, such that the driver is in danger of traffic accident. In the case of using voice data, the road traffic information transmission apparatus needs a large amount of data to be processed, and particularly, it requires a large amount of memory to perform a natural voice mixing operation.

A method for completing/processing simple text data classifies word or syllable data according to the frequency of uses of voice data, stores the classified word as one word, and stores the remaining data other than the classified word as text data. Therefore, voice data is stored in a memory while being classified according to the word data and the text data. The stored data is compressed and stored using an ADPCM (Adaptive Difference Pulse Code Modulation) scheme in such a way that the total amount of stored data can be reduced. In the case of using voice data, the number of unit roads processable for a predetermined time such as a road traffic information data reception period (e.g., 1 minute) is limited, for example, about 5 unit roads.

In brief, the road traffic information transmission apparatus shown in FIG. 1 extracts ID information of a unit road contained in a prescribed area on an electronic map, selects only road traffic information corresponding to the unit road ID information extracted from among received teletext broadcast data, and informs the user or driver of the selected road traffic information. Therefore, the road traffic information transmission apparatus has a disadvantage in that it selectively informs a user of only road traffic information of a specified area requested by the driver even though it receives a large amount of road traffic information received via a teletext broadcast. Further, the selected road traffic information is audibly output to the user or driver, such that its meaning can be quickly and accurately transmitted to the user or driver, resulting in the improvement of safety while driving a vehicle.

In addition, the road traffic information transmission apparatus can be applied to a typical vehicle navigation system.

The data extractor 105, the data selector 107, and the voice processor 109 can be implemented in the form of a program module, respectively. That is, they 105, 107 and 109 can be fabricated as a software program, respectively. The vehicle navigation controller 103, the data extractor 105, the data selector 107, and the voice processor 109 may be implemented with a single processor 110.

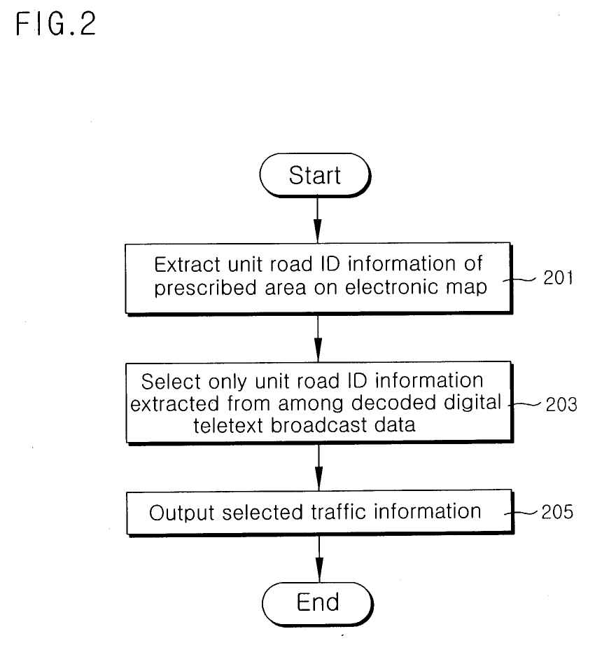

FIG. 2 is a flow chart illustrating a method for providing a user with road traffic information in accordance with the present invention. This road traffic information transmission method of FIG. 2 will hereinafter be described in more detail with reference to FIGS. 1 and 2.

Referring to FIGS. 1 and 2, a data extractor 105 extracts unit road ID information contained in a prescribed area on an electronic map at step 201. The data selector 107 selects only road traffic information corresponding to the unit road ID information extracted at the step 201 from among decoded digital teletext broadcast data at step 203. Then, the vehicle navigation controller 103 displays the selected road traffic information to inform a driver of the selected road traffic information at step 205, or the voice processor 109 fabricates the road traffic information selected at step 203 in the form of voice data to audibly inform the driver of the selected road traffic information at step 205.

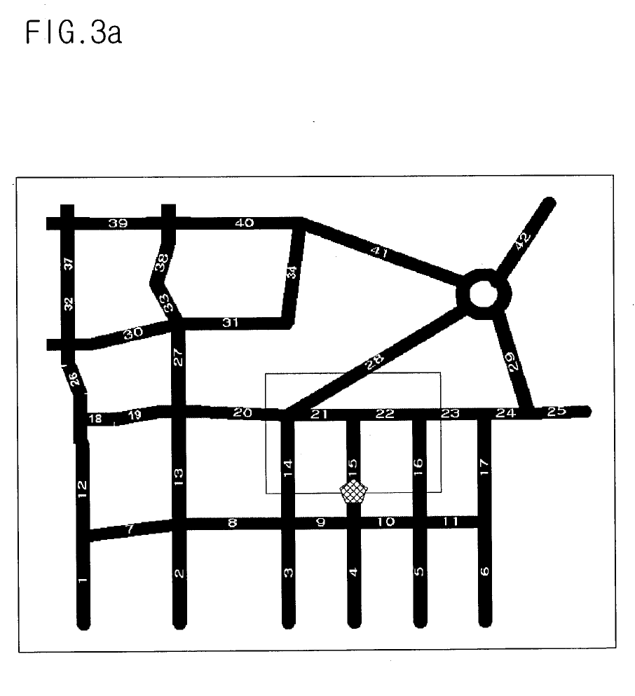

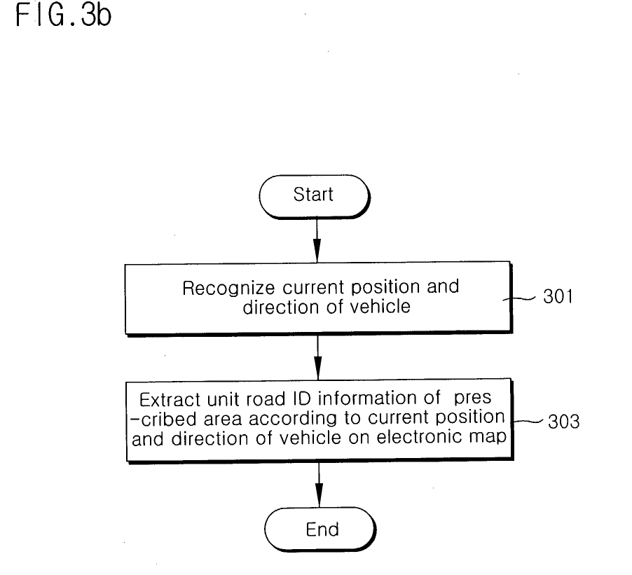

FIG. 3a is an exemplary view illustrating a method for extracting road traffic information using window information from reception data. FIG. 3b is a flow chart illustrating the road traffic information extraction method shown in FIG. 3a.

Referring to FIG. 3a, a method for extracting road traffic information (e.g., unit road ID information, link information, and node information) using window information selects a specified area corresponding to a window of a predetermined size in a vehicle's traveling direction on the basis of a unit road (e.g., a link or node) on which a vehicle is positioned, and extracts road traffic information from the selected area. For example, in the case where the vehicle is positioned on a unit road #15 as shown in FIG. 3a, an appropriate window size is determined, and desired road traffic information (e.g., unit roads #14, #15, #16, #21 and #22) is then extracted from road traffic information associated with the determined window size.

The above-identified operations will hereinafter be described in detail with reference to FIG. 3b.

Referring now to FIG. 3b, the data extractor 105 recognizes a current position and direction of a vehicle at step 301. The data extractor 105 extracts unit road ID information of a prescribed area according to the current position and direction of vehicle at step 303.

The above method for extracting road traffic information using window information has the following characteristics. As shown in FIG. 3a, road traffic information of a congested road is transmitted to the driver while the vehicle is in motion. A window size is reset according to a current vehicle position, such that the window is shifted to a predetermined location on the electronic map, and the size of window can be adjusted according to traffic volume to be transmitted to the driver.

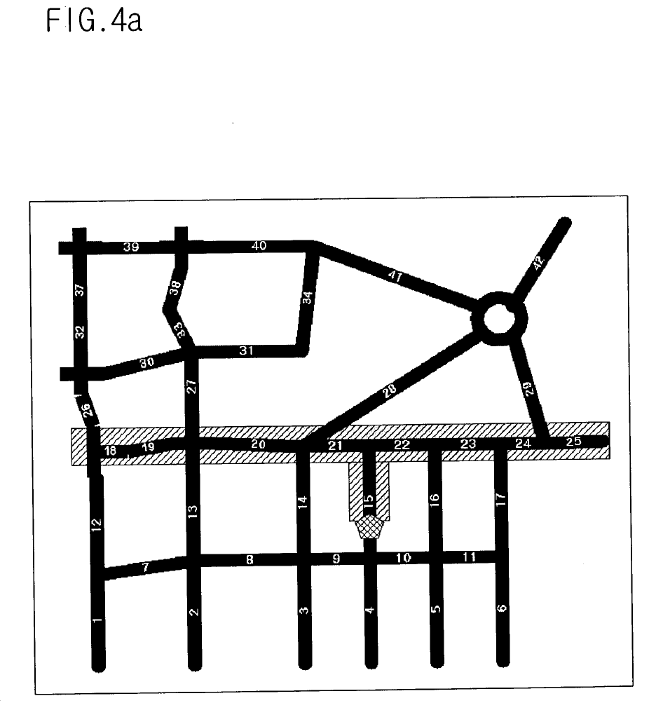

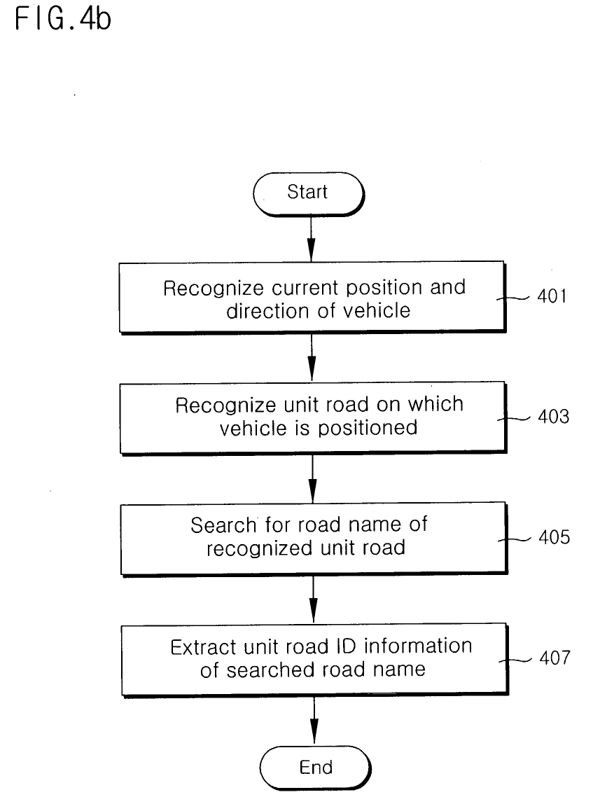

FIG. 4a is an exemplary view illustrating a method for extracting road traffic information from reception data using road name information. FIG. 4b is a flow chart illustrating the road traffic information extraction method shown in FIG. 4a.

Considering that a driver tends to run a vehicle along his or her desired road while driving the vehicle, there is provided the above method for extracting the road traffic information (e.g., unit road ID information, link information, and node information) using road name information. According to this road traffic information extraction method, unit road ID information of a current vehicle is obtained, and then road traffic information of unit roads corresponding to a name (e.g., a national road name or an express highway name) of the road on which the vehicle is located is extracted. For example, provided that a vehicle is located on a unit road #15 as shown in FIG. 4a, ID information of a unit road #18, #19, #20, #21, #22, #23, #24, or #25 corresponding to road names associated with the road #15 is extracted from an electronic map.

The above-identified operations will hereinafter be described in detail with reference to FIG. 4b.

Referring now to FIG. 4b, the data extractor 105 recognizes a current position and a traveling direction of a vehicle at step 401. The data extractor 105 recognizes a unit road on which the vehicle is currently positioned on an electronic map at step 403. The data extractor 105 searches for a road name of the recognized unit road at step 405. Then, the data extractor 105 extracts unit road ID information corresponding to the searched road name at step 407.

This above method shown in FIG. 4b is most effective on the condition that a vehicle runs along only one road.

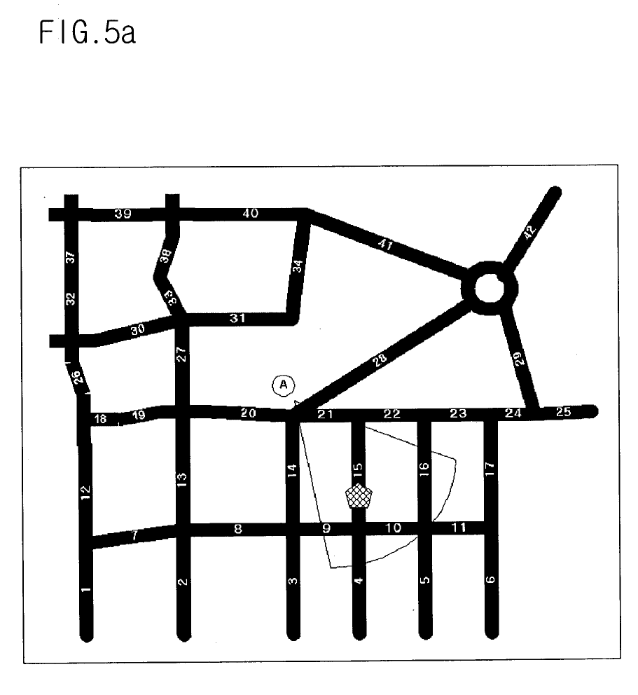

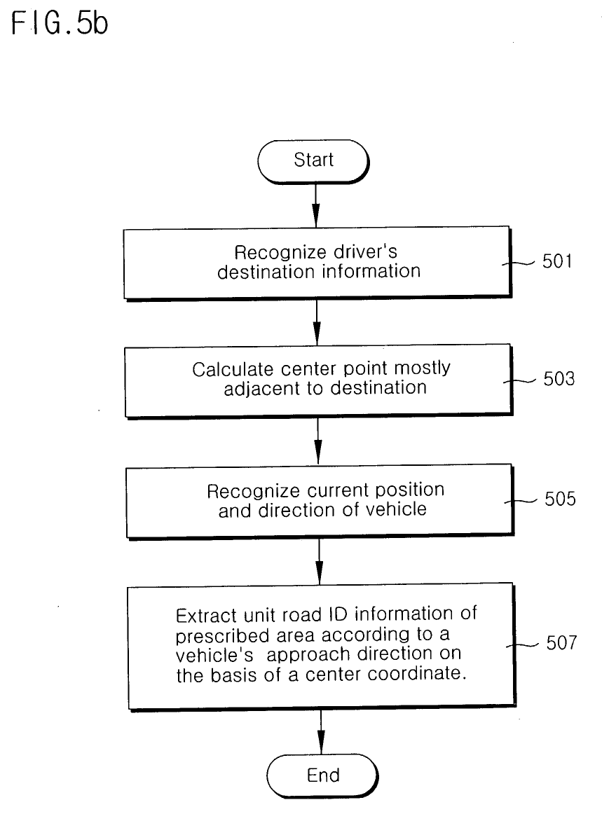

FIG. 5a is an exemplary view illustrating a method for extracting road traffic information from reception data using center point information. FIG. 5b is a flow chart illustrating the road traffic information extraction method shown in FIG. 5a.

The road traffic information extraction method shown in FIGS. 5a-5b is based on the fact that a driver tends to run a vehicle toward a prescribed destination, and is equal to a method for extracting road information (e.g., unit road ID information, link information, and node information).

In more detail, the above road traffic information extraction method shown in FIGS. 5a-5b separates a specified area having traffic information to be transmitted to the driver from an overall area of an electronic map on the basis of important road traffic places contained in the electronic map. For example, provided that a road traffic place “A” is determined on the electronic map as shown in FIG. 5a, an overall area displayed on an electronic map is divided into many sections. ID information of unit roads #9, #10, #15, #16, and #21 associated with a prescribed area is extracted according to a vehicle's approach direction on the basis of a center coordinate.

The above-identified operations will hereinafter be described in detail with reference to FIG. 5b.

The data extractor 105 recognizes driver's destination information using a user interface 113 at step 501. The data extractor 105 searches for a center point (e.g., an important road traffic place) being closest to the destination at step 503. The data extractor 105 recognizes a current position and a traveling direction of a vehicle at step 505. On the basis of the center coordinate, the data extractor 105 extracts unit road ID information of a prescribed area located in an approach direction of the vehicle at step 507.

The above method shown in FIG. 5b is effectively adapted to the case where the driver drives his or her vehicle on the basis of a specified center point or coordinate, and all roads are arranged in the form of radial roads.

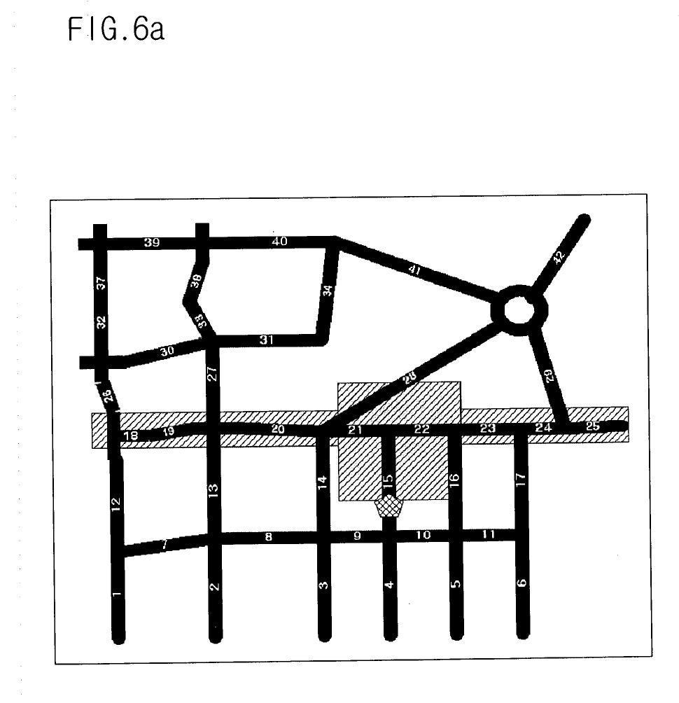

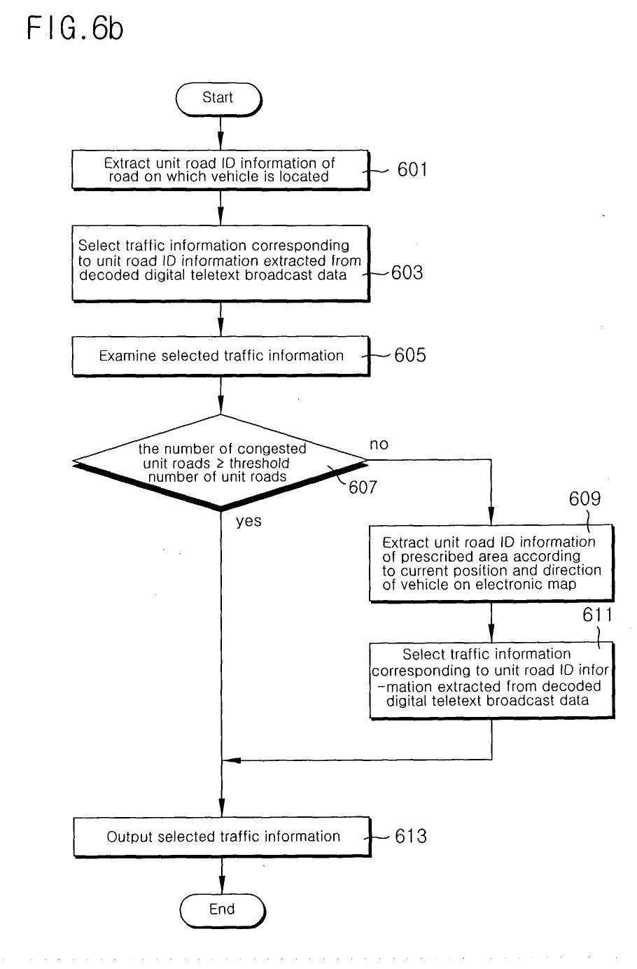

FIG. 6a is an exemplary view illustrating a method for providing a user with road traffic information using a mixed scheme. FIG. 6b is a flow chart illustrating the road traffic information transmission method shown in FIG. 6a.

The mixed scheme is based on a method for adapting road name information to provide a driver with road traffic information, and at the same time uses window information at an adjacent crossing point such as a crossroads, such that road traffic information can be effectively transmitted to the driver. The mixed scheme has a fixed data processing rate irrespective of areas or regions on the electronic map. The mixed scheme informs the driver of road traffic information associated with unit roads corresponding to a specified road (e.g., the national roads, express highway, local roads, and roads for industrial use, etc.) on which the vehicle is located. If there is spare time in an overall processing time because a status value for indicating stalled vehicle information is lower than a threshold value, the mixed scheme selects a prescribed window at an adjacent crossing point such as a crossroads, and informs the driver of road traffic information, such that road traffic information can be effectively transmitted to the driver.

The above-identified operations will hereinafter be described in detail with reference to FIG. 6b.

Referring to FIG. 6a, the data extractor 105 recognizes a current position and direction of a vehicle, recognizes a unit road having the vehicle on an electronic map, searches for a road name of the recognized unit road, and extracts unit road ID information corresponding to the searched road name at step 601. The operations at step 601 are described in more detail in FIG. 4b.

The data selector 107 selects only road traffic information corresponding to the unit road ID information extracted at the step 201 from among decoded digital teletext broadcast data at step 603. Then, the data selector 107 determines whether road traffic information of the selected unit road indicates a congested road at step 603, and determines whether the number of congested unit roads is higher than a reference number of congested unit roads that can be processed within a prescribed time at step 607.

In this case, the prescribed time indicates the remaining time (e.g., 1 minute) elapsed until the next teletext broadcast data is received. The reference number of congested unit roads is equal to a maximum number of unit roads (e.g., five unit roads) being output within the remaining time during which stalled vehicle information is generated.

If it is determined at step 607 that the number of congested unit roads is higher than a reference number of congested unit roads that can be processed within a prescribed time, the vehicle navigation controller 103 displays the road traffic information of congested unit roads to inform the driver of the selected road traffic information at step 613, or the voice processor 109 fabricates the road traffic information selected at step 605 in the form of voice data to audibly inform the driver of the selected road traffic information at step 613.

If it is determined at step 607 that the number of congested unit roads is lower than a reference number of congested unit roads that can be processed within a prescribed time, the data extractor 105 extracts unit road ID information of a prescribed area according to a current position and direction of a vehicle on an electronic map at step 609. The data selector 107 selects road traffic information corresponding to the unit road ID information extracted at the step 609 from among decoded digital teletext broadcast at step 611. Thereafter, the vehicle navigation controller 103 displays the road traffic information selected at steps 605 and 611 to inform the driver of the selected road traffic information at step 613, or the voice processor 109 fabricates the road traffic information selected at steps 605 and 611 in the form of voice data to audibly inform the driver of the selected road traffic information at step 613.

Referring to FIG. 6b, teletext broadcast data is periodically received, for example, every 1 minute. In this case, if a time during which previously received teletext broadcast data is processed and necessary traffic information is transmitted to the driver is shorter than a prescribed time elapsed until the next teletext broadcast data having the latest information is received, the method shown in FIG. 6b is characterized in that not only a first navigation method but also a second navigation method can be used at the same time, if necessary. In this case, the first navigation method provides the driver with road traffic information on the basis of road name information, and the second navigation method provides the driver with road traffic information on the basis of window information.

Particularly, the mixed scheme shown in FIG. 6b can be effectively applied to the case where road traffic information is transmitted to the driver using a voice message.

On the other hand, in accordance with a preferred embodiment of the present invention, a method for extracting unit road ID information from an electronic map can calculate an optimum path from a starting point to a destination, and can extract unit road ID information corresponding to the optimum path. In this case, it should be noted that the optimum path is calculated in real time until the next road traffic data is received.

In order to perform this real-time process, a window centering around a starting point and a destination is created instead of calculating data of all nodes contained in an overall network, and an optimum path in a sub-network extracted by window information is formed.

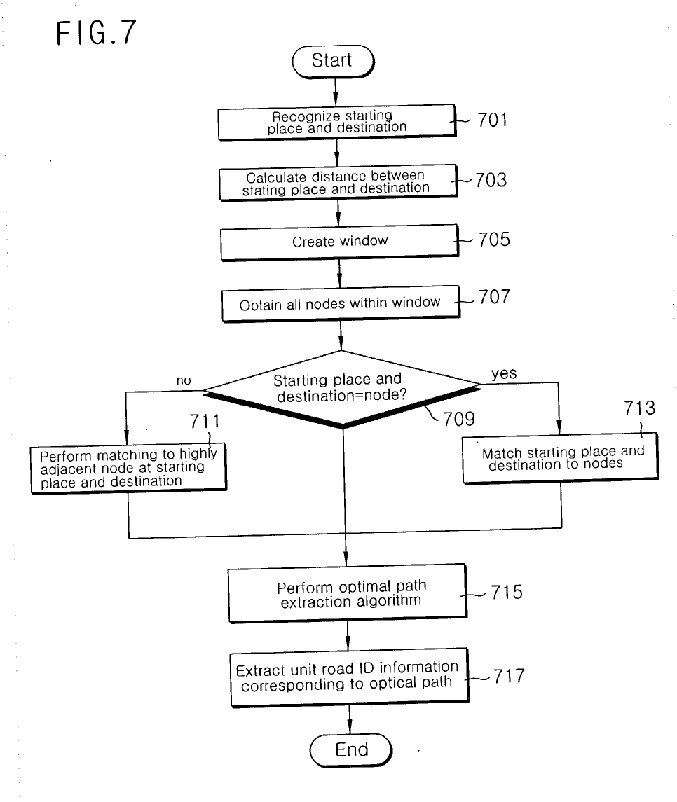

FIG. 7 is a flow chart illustrating a method for extracting unit road ID information by calculating an optimal path from a current position to a destination in accordance with a preferred embodiment of the present invention.

Referring to FIG. 7, the data extractor 105 recognizes driver's destination information entered from the user interface 113, and recognizes a current position and direction of a vehicle at step 701.

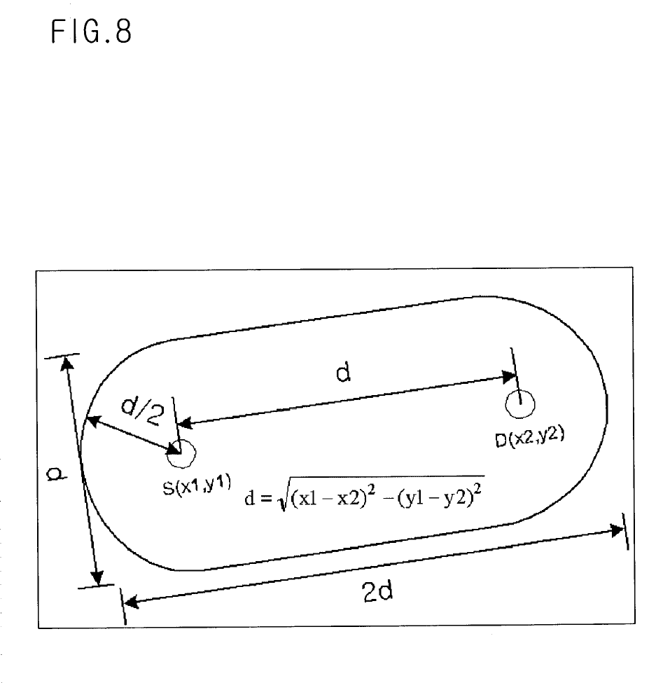

The data extractor 105 calculates a distance “d” from a vehicle's current position and a destination at step 703 using an algorithm shown in FIG. 8, and then creates a window of a predetermined size “0.5 d” according to the calculated distance “d” at step 705.

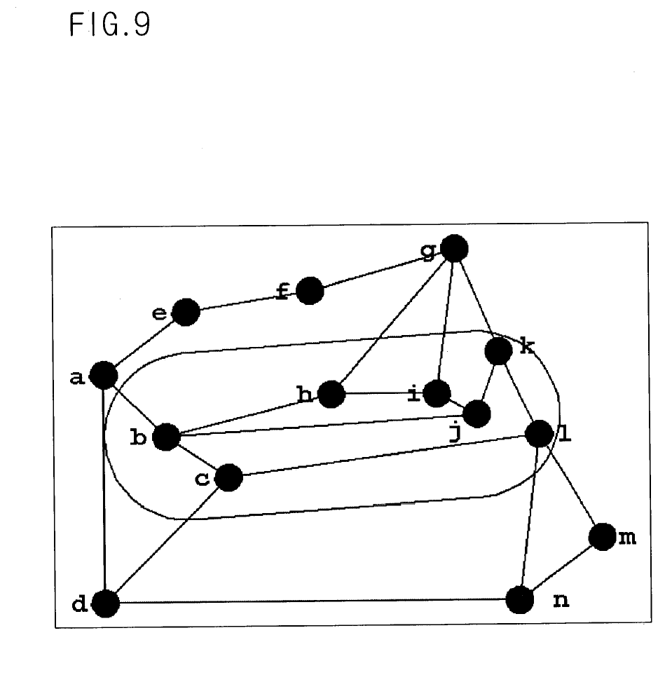

The data extractor 105 extracts the list of nodes, contained in an overall road network of an electronic map, from the created window at step 707. Therefore, as shown in FIG. 9, there are a lot of nodes a˜n in an overall road network of an electronic map, but nodes obtained by window information are only a small number of nodes b, c, h, i, k, and 1.

In the meantime, in order to obtain an optimum path from a current position to a destination of a vehicle, the current position and the destination of the vehicle should be respectively matched with corresponding nodes contained in a sub-network created by window information. Therefore, the data extractor 105 determines whether the current position and the destination of the vehicle are respectively equal to corresponding node information contained in the sub-network at step 709.

If it is determined at step 709 that the current position and destination of the vehicle are not identical with the corresponding nodes, the data extractor 105 is matched with the closest node at step 711.

If it is determined at step 709 that the current position and destination of the vehicle are identical with corresponding node information contained in a sub-network, the data extractor 105 is matched with this identical node at step 713.

Thereafter, the data extractor 105 performs an optimum path extraction algorithm to calculate an optimum path from a current position and a destination of the vehicle at step 715, and then extracts unit road ID information corresponding to the calculated optimum path at step 717.

Considering the aforementioned description related to FIG. 7, a network size used for extracting the optimum path is unrelated to the size of a real network, and the optimum path extraction is performed using the created sub-network, such that the optimum path can be calculated in real time.

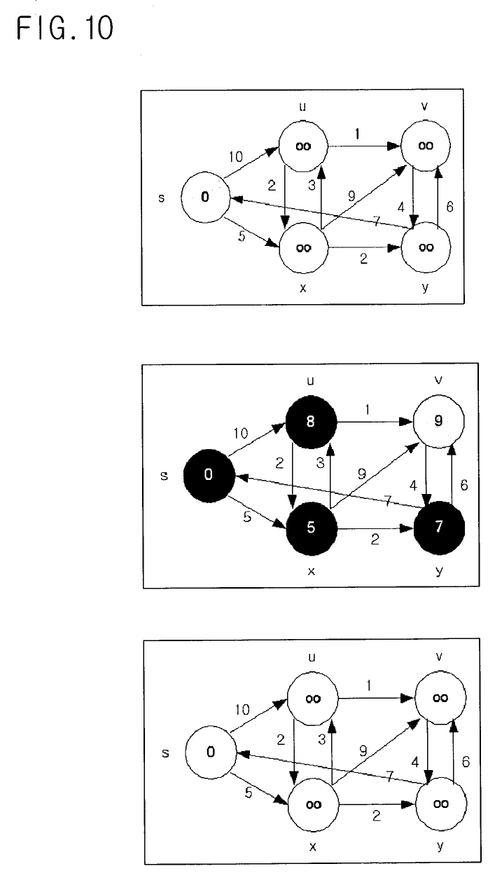

In the meantime, Dijkstra's algorithm, well-known to those skilled in the art, may be adapted as such an optimum path extraction algorithm. Dijkstra's algorithm will hereinafter be described in detail with reference to FIG. 10.

FIG. 10 is a conceptual diagram of Dijkstra's algorithm in accordance with the present invention. In the case where links contained in the road network are denoted by circles interconnected by arrows, a value marked on each arrow indicates a cost variable, and a value marked on each circle indicates the sum of cost variables contained in a corresponding path. In more detail, Dijkstra's algorithm allows individual nodes, starting from the node “s”, to select a node having a minimum value. If a corresponding node is determined to be a node “x”, the node “x” determines whether a destination node is the node “x”. By repeating this operation two times, there is provided the final result created on the condition that the destination is equal to the node “u”. In this case, the optimum path information is contained in the result list, and the sum of cost variables needed for this optimum path is 8. In this way, the aforementioned operations are repeated until all the nodes are marked with any number or symbol, such that all optimum paths from the node “s” to a desired destination can be effectively calculated.

As apparent from the above description, a road traffic information transmission apparatus and method according to the present invention selects road traffic information associated with a specified area requested by a driver from among all road traffic information transmitted to the driver using teletext broadcast data (e.g., DARC) being broadcast to unspecified people or drivers, irrespective of a specified driver's location, and thus quickly informs the driver of the selected road traffic information.

The present invention informs the driver of the selected road traffic information using voice data or message, such that the driver quickly and accurately recognizes the road traffic information and the driver is able to continue driving safely.

Because the present invention does not output all road traffic broadcast data being periodically received, but outputs only necessary data selected from the road traffic broadcast data, a real-time data processing effect is achieved.

Further, the present invention is implemented with GPS signals and electronic map DB signals, and is applied to a vehicle navigation system using the GPS signals and the electronic map DB signals.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for providing a user with road traffic information, which gains access to needed electronic map data stored in an electronic map database (DB), displays the accessed electronic map data on a display screen, receives a GPS (Global Positioning System) signal, and reflects current position and direction information of a vehicle on the electronic map, said apparatus comprising:
a teletext broadcast receiver for receiving teletext broadcast signals, decoding the teletext broadcast signals, and outputting digital teletext broadcast data;
a data extractor for extracting unit road identification (ID) information of a prescribed area contained in the electronic map;
a data selector for selecting road traffic information corresponding to the unit road ID information extracted by the data extractor from among all unit road ID information of an overall road network contained in the digital teletext broadcast data; and
an external data output unit for processing the road traffic information selected by the data selector, and outputting resultant road traffic information.

2. The apparatus as set forth in claim 1, wherein the external data output unit includes:
a voice memory for storing unit road ID information used as the digital teletext broadcast data and current road traffic condition information code for every unit road as voice data; and
a voice processor for examining unit road ID information contained in the road traffic information selected by the data selector and current road traffic condition information code for every unit road, extracting voice data corresponding to the examined information from the voice memory, audibly reproducing the extracted voice data, and outputting the reproduced voice data.

3. An apparatus for providing a user with road traffic information, comprising:
a GPS (Global Positioning System) receiver for providing current position information of a vehicle;
an electronic map database (DB) for storing electronic map data;
a teletext broadcast receiver for receiving a teletext broadcast signal, decoding the teletext broadcast signal, and providing digital teletext broadcast data; and
a processor for accessing needed electronic map data stored in the electronic map DB, displaying the accessed electronic map data on a display screen, reflecting current position and direction information of the vehicle on the electronic map, extracting unit road identification (ID) information of a prescribed area on the electronic map, selecting road traffic information corresponding to the extracted unit road ID information from among all road traffic information for every unit road of an overall road network contained in the digital teletext broadcast data, and outputting the selected road traffic information.

4. The apparatus as set forth in claim 3, further comprising:
a voice memory for storing unit road ID information used as the digital teletext broadcast data and current road traffic condition information code for every unit road as voice data; and
wherein the processor examines unit road ID information contained in the selected road traffic information and current road traffic condition information code for every unit road, extracts voice data corresponding to the examined information from the voice memory, audibly reproduces the extracted voice data, and outputs the reproduced voice data.

5. A method for providing a user with road traffic information, which gains access to needed electronic map data stored in an electronic map database (DB), displays the accessed electronic map data on a display screen, receives a GPS (Global Positioning System) signal, and reflects current position and direction information of a vehicle on the electronic map, said method comprising the steps of:
a) receiving teletext broadcast signals, decoding the teletext broadcast signals, and outputting digital teletext broadcast data;
b) extracting unit road identification (ID) information of a prescribed area contained in the electronic map;
c) selecting road traffic information corresponding to the extracted unit road ID information from among all unit road ID information of an overall road network contained in the digital teletext broadcast data; and
d) outputting the selected road traffic information.

6. The method as set forth in claim 5, wherein the step (d) includes the steps of:
d-1) examining unit road ID information contained in the road traffic information selected at the step (c) and current road traffic condition information code for every unit road, and extracting voice data corresponding to the examined information; and
d-2) audibly reproducing the voice data extracted at the step (d-1), and outputting the reproduced voice data.

7. The method as set forth in claim 6, wherein the step (b) includes the steps of:
b-1) recognizing current position and direction information of the vehicle; and
b-2) determining a prescribed area according to the current position and direction information of the vehicle on the electronic map, and extracting unit road ID information associated with the prescribed area.

8. The method as set forth in claim 6, wherein the step (b) includes the steps of:
b-3) recognizing current position and direction information of the vehicle;
b-4) searching for name information of a unit road on which the vehicle is positioned on the electronic map; and
b-5) extracting unit road ID information corresponding to the unit road name searched at the step (b-4).

9. The method as set forth in claim 6, wherein the step (b) includes the steps of:
b-6) recognizing destination of a driver;
b-7) calculating a center coordinate closest to the destination;
b-8) recognizing current position and direction information of the vehicle; and
b-9) extracting unit road ID information associated with a prescribed area located in an approach direction of the vehicle directed to the center coordinate, on the basis of the center coordinate.

10. The method as set forth in claim 6, wherein the step (b) includes the steps of:
b-10) recognizing destination information of a driver, and current position and direction information of the vehicle;
b-11) creating a window of a prescribed diameter and width to include the current position and direction information of the vehicle;
b-12) obtaining a road network's node contained in the window;
b-13) calculating an optimum path from the current vehicle position to the destination using the road network's node obtained at the step (b-12); and
b-14) extracting unit road ID information corresponding to the optimum path calculated at the step (b-13).
